(19) United States
(12) Patent Application Publication
(10) Pub. No.: US 2005/0131766 A1
(43) Pub. Date: Jun. 16, 2005

(54) System for creating and associating personalized audio messages with remotely purchased articles

(76) Inventor: Matthew Ciesicki, San Francisco, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/733,749

(22) Filed: Dec. 11, 2003

(51) Int. Cl. G06F 17/60

(52) U.S. Cl. 705/26

(57) ABSTRACT

A system for creating and associating personalized audio messages with remotely purchased articles.

### BACKGROUND OF THE INVENTION

1. Field of the Invention

The present invention relates to personalized audio messages, and in particular to an integrated system for seamless generation and association of personalized audio messages with remotely purchased articles.

2. Description of the Related Art

The market for gifts purchased by telephone or over the Internet and delivered directly to the gift recipient is large and continues to grow. The total size of the market for goods that are classified by the North American Industry Classification System as sold through retail electronic and mail order shopping channels was $117 billion in 2002, with catalog and telephone orders comprising $74 billion of the total and e-commerce making up the $43 million balance. Forrester Research projects that sales in this channel will grow to $324 billion by 2008.

However, the efficiency and timesavings of purchasing gifts remotely comes at a price. No longer does the recipient receive the personal touches that have traditionally meant so much in gift giving: the emotional connection seeing and talking to the gift giver; and of receiving a personal note written by the hand of the giver. One of the biggest challenges to growing sales of gifts purchased through remote ordering methods (catalog, television/telephone and internet channels) and direct-delivered to the gift recipient is the unsatisfactory personalization and customization of the gift. More than 73% of the respondents cited personalization as a major contributor to their most satisfying purchasing experience according to a study by software maker Kana, Inc. Conversely, 34% noted that a lack of personalization contributed to their least satisfying experience.

### SUMMARY OF THE INVENTION

It is therefore an advantage of the present invention to provide a system allowing merchants to offer their articles over the Internet or telephone which is sent to a recipient with an audio message personalized by the purchaser to emotionally connect the purchaser and the recipient.

It is another advantage of the present invention to provide a system allowing a remotely ordered article to be sent directly to a recipient along with an audio message personalized in the voice of the purchaser and with content customized by the purchaser.

It is a further advantage of the present invention to allow a purchaser to generate a personalized audio message at the time an article is remotely purchased.

It is another advantage of the present invention to allow a merchant to associate a personalized message with a purchased article where the location where the order is placed is different than the location where the article is stocked.

These and other advantages are provided by the present invention, which in embodiments relate to a system for creating and associating personalized audio messages with remotely purchased article. When ordering an article from a merchant's commerce application server over the Internet, the purchaser is presented with the option to attach a personalized message. If a personalized audio message is to be created and associated with a purchased article, the merchant's commerce application server sends an order message containing order, merchant and purchaser information to a mail server in a central data center.

After the order message is received, the mail server generates a PIN message that is sent to the purchaser via email including the required information for the purchaser to call and log into the data center and record the personal message. Once a purchaser receives the PIN and other information, the purchaser then calls the data center to record the personal audio message. The message is then forwarded to the merchant's distribution center, where it is stored. When the purchaser's order is filled, the associated stored audio message is accessed and downloaded onto a small form factor sound module. The module is then affixed to the purchased article and sent to the intended recipient.

Upon receiving and opening the package, the recipient can play the audio message in the giver's own voice and personal words while opening the gift, and enjoying the feeling of the close connection to the giver at the exact emotional instant the gift is opened.

### BRIEF DESCRIPTION OF THE DRAWINGS

The present invention will now be described with reference to the drawings in which:

FIG. 1 is a schematic view of the present invention for creating a personalized message and associating that message with an article purchased over the Internet;

FIG. 2 is a flow chart of the system shown in FIG. 1.

FIG. 3 is a schematic representation of the data center according to the present invention; and

FIG. 4 is a schematic representation of the loader station according to the present invention; and

FIG. 5 is a schematic view of an alternative embodiment of the present invention for creating a personalized message and associating that message with an article purchased over the Internet.

### DETAILED DESCRIPTION

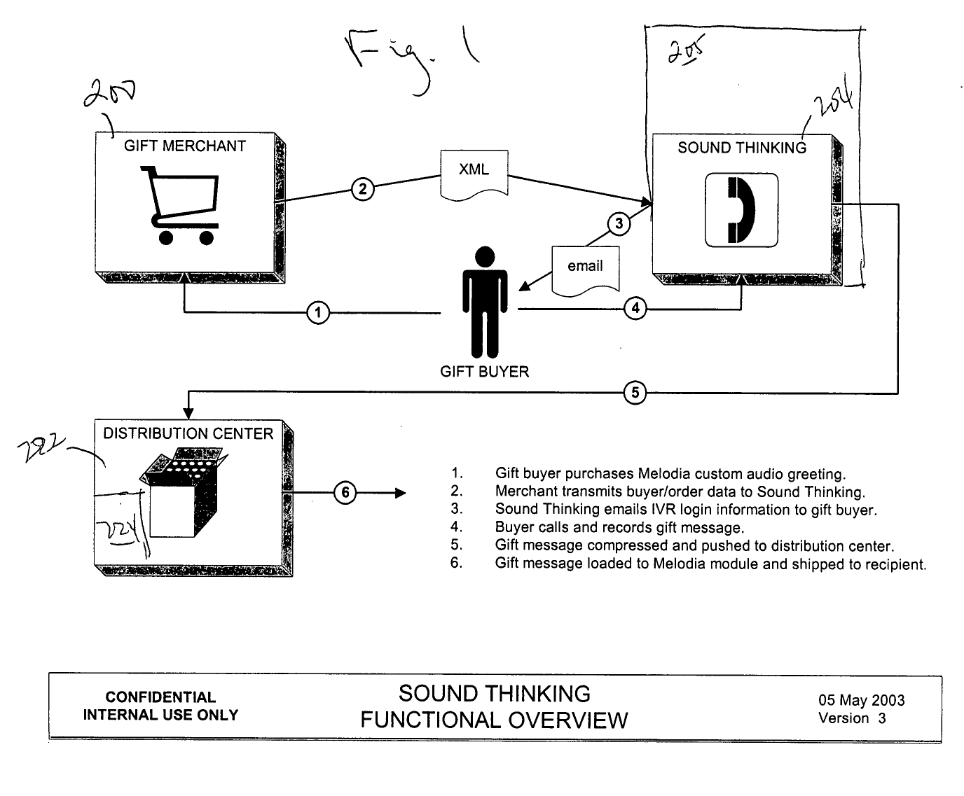

The present invention will now be described with reference to FIGS. 1 through 5, which in embodiments relate to a system for creating and associating personalized audio messages with remotely purchased articles. These articles may typically be any variety of gifts, but can be any article that is purchased and shipped to a recipient. It is understood that the present invention may be embodied in many different forms and should not be construed as being limited to the embodiments set forth herein. Rather these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

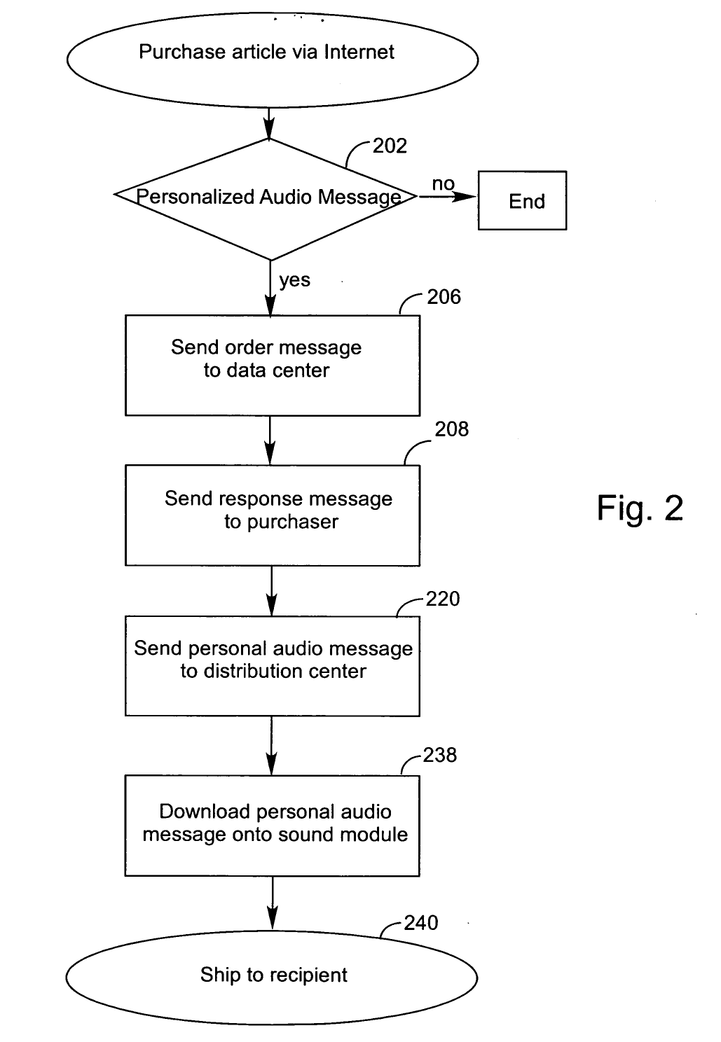

Referring now to FIGS. 1 and 2, there is shown a schematic representation and a flow chart, respectively of the system according to the present invention for generating and affixing an audio message to an article purchased over the Internet. In general, the system allows a purchaser to remotely purchase an article and have the article sent to a recipient together with a message personalized by the purchaser. When ordering an article from a merchant's commerce application server 200 over the Internet, at some point during the purchase process, for example after an article is selected or purchased, a option is presented to the purchaser to attach a personalized message according to the present invention in a step 202. This option may be presented to the user as an active server page (ASP) on the merchant's commerce application server, or as a separate page, pop-up or hyperlink on the merchant's commerce application website.

The merchant's commerce application server may include custom-developed or standard modular software component. If the purchaser wishes to attach a personalized audio message, the software component is used by the merchant's commerce application to send an order message to a mail server 204 at a data center 205 in a step 206. This preferably occurs immediately, but may be done after the purchaser completes his/her transaction on the merchant's commerce application server. Typically, the merchant will generate an order number for the purchase which is stored on the merchant's network and used by the merchant to access information about the purchase. This same order number may be used by the present invention to associate a personalized greeting with the purchase. In particular, The order message sent to the mail server 204 preferably includes the order number and other information such as merchant identification and email address of merchant's distribution center and purchaser contact information, for example email address, billing address and/or telephone number. The order message may additionally include recipient information such as name, address, telephone and/or email contact in alternative embodiments. The order message sent to the mail server 204 may be sent using various protocols including XML.

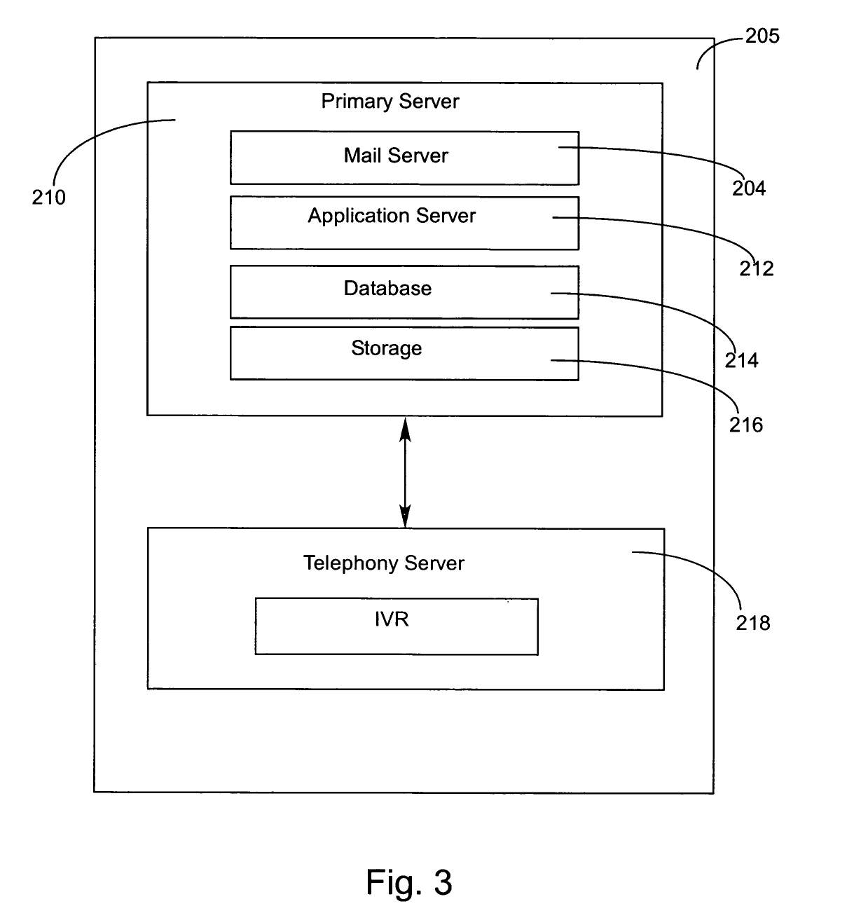

FIG. 3 is a schematic representation of the data center 205. The data center 205 preferably includes a primary server 210 including the mail server 204, as well as an application server 212, a database repository 214, and memory storage 216. The application server 212 receives and parses the order message, writes data to the database 214, generates a unique PIN and sends the PIN message to the purchaser and/or merchant. The database 214 may be an object or relational database for storage of PINs, purchaser information, order data, merchant data and tracking information. Database functionality may further include generation of PINs, and integration with the telephony system, and automatic compression of audio files. The memory storage 216 is used for storing a personal audio message as explained hereinafter.

In a step 208, after the order message is received, the mail server 204 generates a PIN message that is sent to the purchaser via email including the required information for the purchaser to call and log into the data center 205 and record the personal message. The PIN message may include a personal identification number, or PIN, to be associated with the buyer's order number, as well as the contact telephone number for the data center and logon instructions. The PIN message may additionally or alternatively be sent from the data center via a telephone call in alternative embodiments. In the event the email to the purchaser gets bounced back to the data center, the mail server 204 may attempt to periodically resend the email message and/or an operator may attempt to contact the purchaser using the additional purchaser identification information contained in the order message.

Once a purchaser receives the PIN and other information, the purchaser then calls into a telephony server 218 also included in the data center 205. The telephony server 218 includes an interactive voice response (IVR) software application that accepts a combination of voice telephone input and touch-tone keypad selection and guides the purchaser through the process of recording a personal audio message, which is stored in memory 216. As part of the recording process, the IVR software provides the purchaser with opportunity to record, re-record, approve and exit the recording process.

In the event the purchaser does record a personalized audio message upon passage of a period of time after the PIN message is sent to the purchaser, the data center 205 may cause a reminder message to be sent to the purchaser prompting them to contact the data center and record their personalized audio message. This reminder message may be sent by email and/or by a telephone call which may be a prerecorded message or by a live person. When a purchaser makes a purchase, they often indicate the manner of shipping, such as for example overnight, second-day delivery etc. The shipping information may also be included in the order message sent to the data center to ensure that one or more reminder messages are sent to the purchaser where a shipment is imminent and the purchaser has not yet recorded their personalized audio message.

Initially, before a merchant is able to offer a purchaser of merchandise the option of attaching a personalized audio message, the merchant must perform an integration and initialization process with the data center. During this process, the merchant designates shipping rules, such as what articles are shipped from which distribution center, as well as other information allowing smooth and seamless integration between the merchant and the data center. A merchant extranet may also be setup allowing the merchant to periodically update and change any information setup during the integration and initialization process.

In a step 220, after the personal audio message is recorded, the message is compressed, for example in MP3 format. It is understood that the message need not be compressed, or may be compressed in other audio compression formats such as WAV format. The compressed audio message is then stored on the memory storage 216, which may be for example a redundant array of independent disks (RAID). Additionally, the mail server 204 then routes the compressed personal audio message to a distribution center 222 using the distribution center email address contained in the order message.

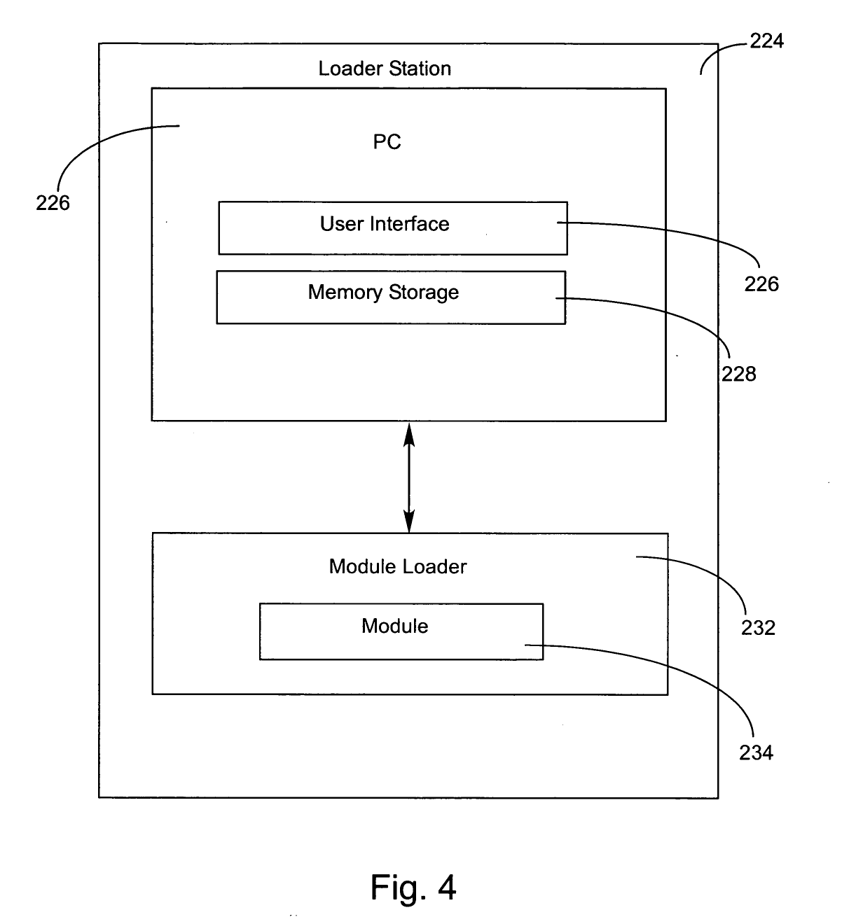

The distribution center is associated with the merchant and has the actual article to be shipped directly to the recipient. According to the present invention, the distribution center preferably includes a loader station 224. As shown in the schematic of FIG. 4, the loader station 224 preferably includes a computing device such as a personal computer (PC) 226 having a user interface 228 and memory storage 230 for storing the compressed personal audio message. The loader station further includes a module loader 232 in communication with the PC 226 capable of receiving a portable sound module 234. During pick and pack of the article at the distribution center, in a step 238 an employee loads a sound module 234 into the loader 232, and then enters the unique order number associated with the purchase into the PC 226 via the user interface 228 or some other data entry method, such as additionally a bar-code scanner. Once the order number is identified by the PC processor, the compressed audio message associated with the order number is downloaded from storage 230 onto the sound module 234.

The sound module 234 is known in the art and is manufactured for example by Apple Gift Corp. of New York. Such modules preferably include a microprocessor, a memory storage, a speaker and a playback button for the recipient to play the recorded message. The modules also may have a small form factor, such as for example about 3¼ inches by 2 inches by ¼ inch. It is understood that the size of the modules may vary in alternative embodiments.

Once the compressed audio message is stored on the sound module, the module may be placed in or affixed to its associated article, or affixed to a card which is in turn placed in or affixed to the associated article. The module may have a pressure sensitive adhesive on one or both sides allowing it to adhere to a surface of the article packaging or card. Once the sound module is affixed to or in the article, the article is then shipped to the recipient per the instructions on the merchant's pick-pack slip in a step 240.

In an alternative embodiment, it is understood that the loader station 224 described above may also be located in retail outlets or even located in individuals' homes. In accordance with this embodiment, when a purchaser makes a purchase, instead of the order message directing the audio message to its distribution center, the purchaser may be given the option to have the recorded message sent to any email address of his/her choosing. Thus, for example, the purchaser can have the audio message sent to a loading station 224 accessible to the purchaser. The sound module is generated as described above, and then the purchaser him or herself affixes the sound module to an article or card and the purchaser then sends the article and/or card to a recipient with the sound module.

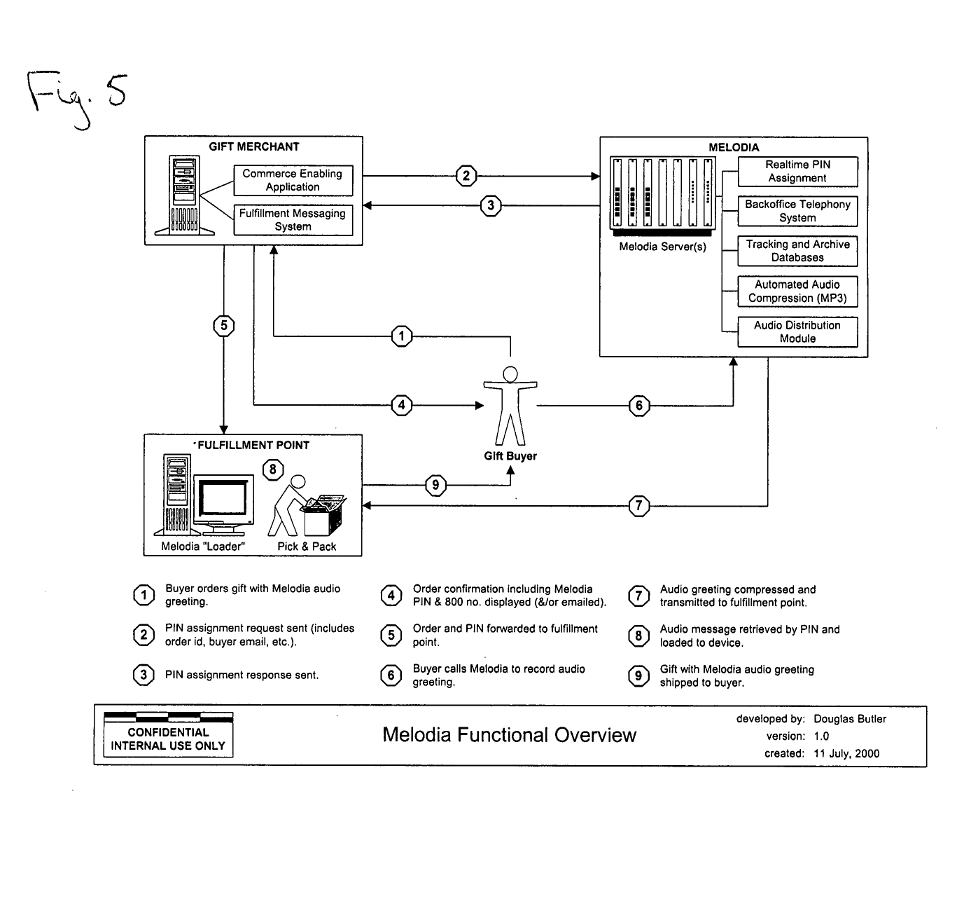

FIG. 5 illustrates an alternative embodiment of the present invention for creating and associating an audio message with an article purchased over the Internet. The purchaser purchases the article on-line as described above, and an order message is generated between the merchant's commerce application server and the data center as described above. However, in this embodiment, the PIN message including the order and purchaser identification information and instructions for contacting the data center to record the audio message is sent back to the merchant's commerce application server. The merchant's commerce application server then displays a web page to the purchaser including the PIN message. This may all occur in real time so as not to slow the merchant's purchase process. The purchaser then contacts the data center to record the audio message and the process continues as described above.

In a further alternative embodiment (not shown), the purchaser may generate the audio message using a microphone attached to his/her computer. This audio message may be sent to the data center, stored and forwarded to the distribution center as described above. Alternatively, the audio message created using a purchasers own microphone may be sent directly to the distribution center together with the article and purchaser identification information.

Instead of the Internet, a purchaser may use the telephone to call in a purchase. In such embodiments, the purchaser calls the merchant and orders the gift by phone and chooses to personalize the gift by purchasing the capability to send a personal audio message. The merchant's order entry system electronically generates an order message that is sent to the data center 205 described above with the order information. The purchaser is also given the order identification and data center log-in information. The purchaser may then be immediately transferred to a call center in the data center to allow the user to confirm his/her identity as by logging in, and then go through the steps described above for recording the audio message. The audio message is stored on memory 216 and forwarded to the distribution center 222 and the process continues as described above. Instead of being immediately transferred to the data center, a purchaser on the telephone may be given the telephone number to contact the data center and record the personalized audio message as described above.

In the embodiments described above, the audio message is created at the time the purchaser makes his/her purchase. In an alternative embodiment of the present invention, individuals may pre-record one or more audio messages prior to making a purchase. In such an embodiment, the individual contacts the data center 205, either by the Internet or over the telephone. The individual logs into a personal account. If it is the first time the individual is contacting the data center, the individual is guided through steps for creating a personal account and login credentials. Once in their account, they can generate a recorded audio message as described above, and the audio message may be compressed and stored in memory 216 as described above. The user is also given a recorded message identification number for the stored audio message.

Thereafter, when the individual makes a purchase, the individual is given the option to attach a personal audio message as described above. The individual then associates the purchase with a message previously recorded and stored in memory 216. This may be accomplished by an applet on the merchant's commerce application server which prompts the purchaser to enter the recorded message identification number which is sent to the data center 205 along with the order message as described above. The data center then sends the prerecorded message indicated by the recorded message identification number to the distribution center along with the order information and the distribution center generates a sound module as described above. The purchaser need not contact the data center in this embodiment. Alternatively, after the purchaser makes the purchase, the order message may be generated and sent to the data center as described above, and the purchaser may be prompted to contact the data center to login and select the prerecorded message to be associated with the order indicated by the order message. The purchaser may be given the opportunity to redo or revise the prerecorded message.

In accordance with the above-described embodiment, an individual may login to his/her account with the data center and pre-record any number of messages which are stored in the data center, the individual receiving a separate recorded message identification number for each such pre-recorded message so that the individual may later associate a particular pre-recorded message with a purchase. The individual may also user a single pre-recorded message for multiple purchased articles.

Up to this point, the present invention has been described as allowing a personal audio message to be created and associated with a purchased article. In an alternative embodiment, the article may be omitted, and a sound module 234 may be created with a personalized audio message and sent with a card alone. The sound module 234 may be generated in a loader station 224 at a distribution center and affixed to a card by a technician at the distribution center, or the sound module 234 may be generated in a loader station 224 accessible to the individual and affixed to a card by the individual.

Although the invention has been described in detail herein, it should be understood that the invention is not limited to the embodiments herein disclosed. Various changes, substitutions and modifications may be made thereto by those skilled in the art without departing from the spirit or scope of the invention as described and defined by the appended claims.

1. A method for creating and associating personalized audio messages with remotely purchased articles, comprising the steps of:
(a) receiving an order message including first information relating to the purchaser, the purchased article and the merchant from whom the article was purchased;
(b) sending a PIN message assigning an identification number to the purchaser;
(c) receiving contact from the purchaser to allow recording of the personalized audio message to be associated with the object;
(d) forwarding the personalized audio message to a loader station where the personalized audio message may be downloaded to a sound module, the sound module to be placed with the purchased article; and
(e) forwarding an identifier to a location associated with the loader station allowing the personalized audio message to be associated with the article.

2. A method for creating and associating personalized audio messages as recited in claim 1, wherein said step (c) of receiving contact from the purchaser comprises contact via the Internet.

3. A method for creating and associating personalized audio messages as recited in claim 1, wherein said step (c) of receiving contact from the purchaser comprises contact via a telephone.

4. A method for creating and associating personalized audio messages as recited in claim 1, further comprising a step (f) of providing security protocols where purchaser is required to enter the identification number received in said step (b).

5. A method for creating and associating personalized audio messages as recited in claim 1, wherein the order message is received from the merchant from whom the article was purchased.

6. A method for creating and associating personalized audio messages as recited in claim 1, wherein said step (b) of sending a PIN message comprises sending the PIN message to the purchaser.

7. A method for creating and associating personalized audio messages as recited in claim 1, wherein said step (b) of sending a PIN message comprises sending the PIN message to the merchant.

8. A method for creating and associating personalized audio messages as recited in claim 1, further comprising a step (g) of storing the personalized audio message after receiving said contact in said step (c).

9. A method for creating and associating personalized audio messages for articles purchased remotely from a merchant, comprising the steps of:
(a) receiving an order message from a first location associated with the merchant, the order message including first information relating to the purchaser, the purchased article and the merchant from whom the article was purchased;
(b) sending a PIN message assigning an identification number to the purchaser;
(c) receiving contact from the purchaser to allow recording of the personalized audio message to be associated with the object;
(d) forwarding the personalized audio message to a loader station at a second location associated with the merchant where the personalized audio message may be downloaded to a sound module, the sound module to be placed with the purchased article; and
(e) forwarding an identifier to the second location allowing the personalized audio message to be associated with the article.

10. A method for creating and associating personalized audio messages as recited in claim 9, wherein said step (c) of receiving contact from the purchaser comprises contact via the Internet.

11. A method for creating and associating personalized audio messages as recited in claim 9, wherein said step (c) of receiving contact from the purchaser comprises contact via a telephone.

12. A method for creating and associating personalized audio messages as recited in claim 9, further comprising a step (f) of providing security protocols where purchaser is required to enter the identification number received in said step (b).

13. A method for creating and associating personalized audio messages as recited in claim 9, wherein the order message is received from the merchant from whom the article was purchased.

14. A method for creating and associating personalized audio messages as recited in claim 9, wherein said step (b) of sending a PIN message comprises sending the PIN message to the purchaser.

15. A method for creating and associating personalized audio messages as recited in claim 9, wherein said step (b) of sending a PIN message comprises sending the PIN message to the merchant.

16. A method for creating and associating personalized audio messages as recited in claim 9, further comprising a step (g) of storing the personalized audio message after receiving said contact in said step (c).
